(19) United States
(12) Patent Application Publication
(10) Pub. No.: US 2018/0030363 A1
(43) Pub. Date: Feb. 1, 2018

(54) BLOCK COPOLYMERS AND THE USE THEREOF FOR IMPROVING THE COLD PROPERTIES OF FUELS OR COMBUSTIBLES

(71) Applicant: Total Marketing Services, Puteaux (FR)

(72) Inventors: Julie PREVOST, Lyon (FR); Valérie HEROGUEZ, Merignac (FR); Floraine COLLETTE, Biganos (FR)

(73) Assignee: Total Marketing Services, Puteaux (FR)

(21) Appl. No.: 15/549,618

(22) PCT Filed: Feb. 9, 2016
(86) PCT No.: PCT/EP2016/052685

§ 371 Date: Aug. 8, 2017

(30) Foreign Application Priority Data
Feb. 11, 2015 (EP) 15305206.3

(51) Int. Cl. C10L 10/14; C10L 1/196; C10L 1/16; C08F 293/00

(52) U.S. Cl. CPC C10L 10/14; C08F 293/005; C10L 1/1963; C10L 1/1641; C08F 2438/01; C10L 2200/0438; C10L 2230/08; C10L 2250/04

(57) ABSTRACT

The invention relates to a block copolymer and the use thereof as a cold resistance additive of a fuel or combustible. The block copolymer comprises: (i) a block A consisting of a chain of structural motifs derived from at least one α,β-unsaturated alkyl methacrylate or acrylate monomer; and (ii) a block B consisting of a chain of structural motifs derived from at least one α,β-unsaturated monomer selected from styrene derivatives, the aromatic ring of which is substituted by at least one group R selected from the groups: C₁ to C₂₄ alkyl esters, and preferably acyclic linear or branched C₁ to C₁₂ hydrocarbonated chains, said chain being substituted by at least one group containing a quaternary ammonium salt. The invention also relates to an additive concentrate containing such a copolymer and to the use thereof as an anti-sedimentation additive, and advantageously, as a TLF booster additive.

The present invention relates to block copolymers and additive concentrates containing such copolymers. The invention relates to the use thereof as additive for fuels or combustibles, in particular the use of such additives for improving the cold resistance properties of fuels or combustibles during the storage thereof and/or the use thereof at low temperature. The present invention also relates to fuel and combustible compositions additized with a cold flow improver (CFI) additive comprising such copolymers.

### PRIOR ART

Fuels or combustibles containing compounds with n-alkyl, isoalkyl or n-alkenyl substituents, such as paraffin waxes, are known to have impaired flow properties at low temperature, typically below 0° C. In particular, it is known that the middle distillates obtained from crude oils of petroleum origin by distillation, such as gas oil or domestic fuel oil, contain differing amounts of n-alkanes or n-paraffins depending on their origin. These compounds containing n-alkyl, isoalkyl or n-alkenyl substituents tend to crystallize with lowering temperature, blocking pipes, pipework, pumps and filters, for example in fuel circuits in motor vehicles. In winter, or in conditions of use of the fuels or combustibles at temperatures below 0° C., the crystallization phenomenon may lead to a reduction in the flow properties of the fuels or combustibles and consequently to difficulties during the transport thereof, storage and/or the use thereof. Operability under cold conditions of fuels or combustibles is important, especially in order to ensure cold engine start. If the paraffins are crystallized at the bottom of the tank, they may be drawn into the fuel circuit on start-up and clog the filters and prefilters, especially, arranged upstream of the injection systems (pump and injectors). Similarly, for the storage of domestic fuel oils, the paraffins precipitate at the bottom of the vessel and may be drawn into, and obstruct, the lines upstream of the pump and of the system for supplying the boiler (spray nozzle and filter).

These problems are well known in the field of fuels and combustibles, and numerous additives or mixtures of additives have been proposed and sold in order to reduce the size of the paraffin crystals and/or change the shape thereof and/or prevent them from forming. As small as possible a crystal size is preferred, because it minimizes the risks of blocking or clogging of the filter. Customary cold flow improvers (CFI) for crude oils and medium distillates are co- and terpolymers of ethylene and vinyl and/or acrylic ester(s), alone or in a mixture. Cold flow improver (CFI) additives intended to lower the cold filter plugging point (CFPP) and the pour point (PP) inhibit the growth of crystals at low temperature by promoting the dispersion of the paraffin crystals; these are, for example, polymers of ethylene and vinyl acetate and/or vinyl propionate (EVA or EVP), also referred to as CFPP (cold filter plugging point) additives. This type of additive, which is very widely known by those skilled in the art, is systematically added to medium distillates of conventional type on leaving the refinery. These additized distillates are used as fuel for diesel engine or as heating combustible. Additional amounts of these additives may be added to fuels sold at filling stations, especially in order to meet extreme cold specifications.

In order to improve both the CFPP and the pour point of the distillates, additives are added to these CFPP additives, having the function of acting in concert with these additives on the pour point of the distillates. The prior art extensively describes such combinations of additives, improving both the cold filter plugging point (CFPP) and the low temperature pour point of conventional hydrocarbon-based distillates.

Mention may be made, by way of example, of patent U.S. Pat. No. 3,275,427, describing a medium distillate of the distillation fraction between 177 and 400° C., containing an additive consisting of 90 to 10% by weight of an ethylene copolymer, comprising from 10 to 30% of vinyl acetate units having a weight-average molar mass of between 1000 and 3000 g.mol⁻¹ and from 10 to 90 weight % of a lauryl polyacrylate and/or a lauryl polymethacrylate of weight-average molar mass varying from 760 to 100 000 g.mol⁻¹.

By way of example of a combination, mention may also be made of document EP0857776, in which alkyl phenol-aldehyde resins, resulting from the condensation of alkyl phenol and aldehyde, have been proposed in combination with ethylene/vinyl ester copolymers or terpolymers, for improving the fluidity of mineral oils.

Document FR2903418 describes, in particular, the use of a combination of a polyacrylate or a polymethacrylate with a cold flow improver (CFI) additive of EVA or EVP type, for revealing the efficacy of CFI additives by amplifying their effect on the CFPP.

Aside from the improvement in the flow of the oil and the distillate, another aim of flow improver additives is to ensure the dispersion of the paraffin crystals, so as to delay or prevent the sedimentation of the paraffin crystals and hence the formation of a paraffin-rich layer at the bottom of storage receptacles, vessels or tanks; these paraffin-dispersing additives are referred to as sedimentation-inhibiting additives or WASA (wax anti-settling additive).

Modified alkyl phenol-aldehyde resins were described in document FR2969620 as sedimentation-inhibiting additive in combination with a CFPP additive.

Due to the diversification of sources of fuel or combustible, there is still a need to find novel additives for improving the properties of fuels or combustibles at low temperature, also referred to as cold resistance properties, especially their properties of flow during the storage thereof and/or the use thereof at low temperature.

This need is particularly great for fuels or combustibles comprising one or more compounds containing n-alkyl, isoalkyl or n-alkenyl substituents having a tendency to crystallize in said fuels or combustibles during the storage and/or use thereof at low temperature.

Thus, the aim of the present invention is to propose novel additives and concentrates containing same which may advantageously be used as additives for improving the cold resistance properties of these fuels or combustibles during the storage thereof and/or the use thereof at low temperature, typically below 0° C., in particular as sedimentation-inhibiting additives.

The aim of the present invention is also to propose novel additives and concentrates containing same which act both on the CFPP and delay and/or prevent the sedimentation of crystals of compounds containing n-alkyl, isoalkyl or n-alkenyl substituents, in particular paraffins.

Finally, another purpose of the invention is to propose a fuel or combustible composition having improved cold resistance properties, in particular at temperatures below 0° C., preferably below −5° C.

### SUBJECT OF THE INVENTION

The subject of the invention is therefore a block copolymer as defined in claim 1, and also an additive concentrate comprising such a block copolymer as defined in claim 15.

The applicant has also discovered that the block copolymer and the additive concentrate make it possible to improve the cold resistance properties of fuels or combustibles comprising one or more compounds containing n-alkyl, isoalkyl or n-alkenyl substituents which have a tendency to crystallize in said fuels or combustibles during the storage and/or use thereof at low temperature.

The applicant discovered that the block copolymer and the additive concentrate according to the invention may be used for delaying or preventing the sedimentation of crystals of compounds containing n-alkyl, isoalkyl or n-alkenyl substituents from the fuel or combustible during the storage thereof and/or the use thereof at low temperature.

In addition, the applicant has formulated fuel or combustible compositions as defined in claim 19.

In particular, the subject of the present invention relates to a block copolymer comprising:

(i) a block A consisting of a chain of structural units derived from one or more α,β-unsaturated alkyl methacrylate or acrylate monomers, and

(ii) a block B consisting of a chain of structural units derived from one or more α,β-unsaturated monomers chosen from styrene derivatives, the aromatic ring of which is substituted by at least one group R chosen from the groups:
C₁ to C₂₄ , preferably C₁ to C₁₂ alkyl esters, more preferentially the acetoxy group, and
linear or branched, preferably acyclic, C₁ to C₁₂, preferably C₁ to C₈, hydrocarbon-based chains, more preferentially alkyl groups, said chain being substituted by one or more groups containing a quaternary ammonium salt, preferably a trialkylammonium salt.

According to a particular embodiment, the block copolymer also comprises (iii) an end chain I consisting of a cyclic or acyclic, saturated or unsaturated, linear or branched, C₁ to C₃₂, preferably C₄ to C₂₄, more preferentially C₁₀ to C₂₄ hydrocarbon-based chain, said chain being located at the terminal position of said block copolymer.

Advantageously, the α,β-unsaturated monomer of the block A is chosen from linear or branched C₁ to C₃₄, preferably C₆ to C₂₄, more preferentially C₈ to C₂₄ alkyl methacrylates or acrylates.

According to a particular embodiment, the α,β-unsaturated monomer of the block B is chosen from styrene derivatives, the aromatic ring of which is substituted by at least one C₁ to C₂₄, preferably C₁ to C₁₂ alkyl ester group, preferably the acetoxy group, said ester group being in the meta, ortho or para position on the aromatic ring, preferably in the para position.

According to another particular embodiment, the α,β-unsaturated monomer of the block B is chosen from styrene derivatives, the aromatic ring of which is substituted by at least one linear or branched, preferably acyclic, C₁ to C₁₂, preferably C₁ to C₈ hydrocarbon-based chain, preferably an alkyl group, said chain optionally being substituted by one or more groups containing a quaternary ammonium salt, preferably a trialkylammonium salt.

According to one variant, the α,β-unsaturated monomer of the block B is chosen from the isomers of (vinylbenzyl)trialkylammonium salts in the ortho, meta or para position, preferably in the para position, pure or in a mixture.

Advantageously, the alkyl substituents of the ammonium are identical or different and are chosen independently from linear or branched, preferably acyclic, C₁ to C₁₀, preferably C₁ to C₄ alkyls, more preferentially the methyl or ethyl group.

According to a particular embodiment, the block copolymer is obtained by controlled block copolymerization, preferably by means of a polymerization initiator comprising the end chain I.

According to a particular embodiment, the block copolymer is a diblock copolymer.

According to a particular preferred embodiment, the block copolymer is represented by the following formula (I) or (II):

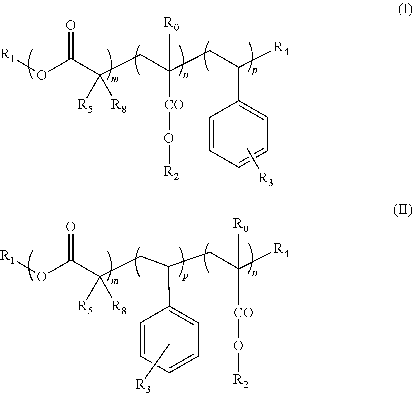

in which
m=0 or 1,
n is an integer between 2 and 20, preferably between 3 and 16,
p is an integer between 2 and 20, preferably between 3 and 16,
R₀ is chosen from hydrogen or the methyl group,
R₁ is chosen from cyclic or acyclic, saturated or unsaturated, linear or branched C₁ to C₃₂, preferably C₄ to C₂₄, more preferentially C₁₀ to C₂₄ hydrocarbon-based chains, preferably alkyl groups,
R₂ is chosen from linear or branched, preferably acyclic, C₁ to C₃₂, preferably C₄ to C₂₄, more preferentially C₁₀ to C₂₄ hydrocarbon-based chains, even more preferentially alkyl groups,
R₃ is a substituent in the ortho, meta or para position, preferably in the para position, on the aromatic ring, chosen from the group consisting of:
   —OCOR₇ groups, in which R₇ is chosen from linear or branched, preferably acyclic, C₁ to C₂₄, preferably C₁ to C₁₂, more preferentially C₁ to C₆ alkyl groups, and
   groups of the following formula (III):

—CH₂—N⁺(R₈)(R₉)(R₁₀)X⁻ (III)
in which
X⁻ is chosen from hydroxide and halide ions and organic anions, preferably chloride, and
R₈, R₉ and R₁₀ are identical or different and are chosen independently from linear or branched, preferably acyclic, C₁ to C₁₀, preferably C₁ to C₄ alkyl groups, more preferentially the methyl or ethyl group,
R₄ is chosen from the group consisting of:
   hydrogen; —OH
   halogens, preferably bromine, and
   cyclic or acyclic, saturated or unsaturated, linear or branched C₁ to C₃₂, preferably C₄ to C₂₄, more preferentially C₁₀ to C₂₄ hydrocarbon-based chains, preferably alkyl groups, said chains being optionally substituted by one or more groups containing at least one heteroatom chosen from N and O,
R₅ and R₆ are identical or different and are chosen independently from the group consisting of hydrogen and linear or branched, more preferentially acyclic, C₁ to C₁₀, preferably C₁ to C₄ alkyl groups, even more preferentially the methyl group.

The subject of the present invention also relates to the use of a block copolymer according to the invention as a sedimentation-inhibiting additive.

Advantageously, the block copolymer according to the invention is used as an additive which improves the cold resistance properties of a fuel or combustible derived from one or more sources chosen from the group consisting of mineral, preferably petroleum, animal, vegetable and synthetic sources. The fuel or combustible comprises one or more compounds containing n-alkyl, isoalkyl or n-alkenyl substituents having a tendency to crystallize in said fuel or a combustible during the storage thereof and/or the use thereof at low temperature. The block copolymer is used in combination with at least one cold flow improver (CFI) additive which improves the low-temperature flow properties of said fuel or combustible during the storage thereof and/or the use thereof at low temperature.

According to a particular embodiment, the block copolymer also makes it possible to amplify the fluidizing effect of the cold flow improver (CFI) additive by improving the cold filter plugging point (CFPP) according to standard NF EN 116 of said fuel or combustible.

The subject of the present invention also relates to an additive concentrate comprising a block copolymer according to the invention, in a mixture with an organic liquid. The organic liquid is inert with respect to the block copolymer and miscible with fuels or combustibles derived from one or more sources chosen from the group consisting of mineral, preferably petroleum, animal, vegetable and synthetic sources. The fuel or combustible comprises one or more compounds containing n-alkyl, isoalkyl or n-alkenyl substituents having a tendency to crystallize in said fuel or a combustible during the storage thereof and/or the use thereof at low temperature.

Advantageously, the additive concentrate comprises at least one cold flow improver (CFI) additive which improves the cold resistance, preferably which improves the low-temperature flow properties of the fuel or combustible during the storage thereof and/or the use thereof at low temperature, said cold flow improver additive preferably being chosen from copolymers and terpolymers of ethylene and vinyl and/or acrylic ester(s) (EVA and/or EVP), alone or in a mixture.

The subject of the present invention also targets the use of such a concentrate for delaying or preventing the sedimentation of crystals of compounds containing n-alkyl, isoalkyl or n-alkenyl substituents from the fuel or combustible during the storage thereof and/or the use at low temperature.

The fuel or combustible is preferably chosen from gas oils, bio-gas oils, mixtures of gas oil and bio-gas oil of Bₓ type, and fuel oils, preferably domestic fuel oils (DFOs).

The subject of the present invention also targets a fuel or combustible composition comprising:
(1) a fuel or combustible derived from one or more sources chosen from the group consisting of mineral, preferably petroleum, animal, vegetable and synthetic sources, advantageously chosen from gas oils, bio-gas oils, mixtures of gas oil and bio-gas oil of Bₓ type, and fuel oils, advantageously domestic fuel oils (DFOs), said fuel or combustible comprising one or more compounds containing n-alkyl, isoalkyl or n-alkenyl substituents having a tendency to crystallize in said fuel or combustible during the storage thereof and/or the use thereof at low temperature,
(2) the block copolymer according to the invention, said copolymer being present in the composition in a sufficient amount to delay or prevent the sedimentation of the crystals from said compounds containing n-alkyl, isoalkyl or n-alkenyl substituents during the storage and/or use of said fuel or combustible (1) at low temperature, and
(3) a cold flow improver (CFI) additive improving the cold resistance, preferably chosen from copolymers and terpolymers of ethylene and vinyl and/or acrylic ester(s) (EVA and/or EVP), alone or in a mixture, said additive being present in the fuel or combustible composition in a sufficient amount to improve the flow behavior at low temperature of the fuel or combustible (1) during the storage thereof and/or the use thereof at low temperature.

According to a particular embodiment, the composition contains at least 10 ppm, preferably at least 50 ppm, advantageously between 10 and 5000 ppm, more preferentially between 10 and 1000 ppm of the block copolymer (2) and at least 10 ppm, preferably at least 50 ppm, advantageously between 10 and 5000 ppm, more preferentially between 10 and 1000 ppm of the cold flow improver additive (3).

The units mentioned in ppm in the present application correspond to ppm by weight unless indicated otherwise.

### DETAILED DESCRIPTION

Other advantages and features will emerge more clearly from the following description. The particular embodiments of the invention are given by way of non-limiting examples.

According to a particular embodiment, a block copolymer comprising at least one block A and at least one block B is prepared according to any known process for controlled block copolymerization starting from at least two types of α,β-unsaturated monomers.

The controlled block polymerization is preferably chosen from controlled radical polymerization, for example, by atom transfer radical polymerization (ATRP), nitroxide-mediated polymerization (NMP), degenerative transfer processes, such as iodine transfer radical polymerization (ITRP) or reversible addition-fragmentation chain transfer (RAFT), polymerizations derived from ATRP, such as polymerizations using initiators for continuous activator regeneration (ICAR) or using activators regenerated by electron transfer (ARGET).

Mention will be made, by way of example, of the publication “Macromolecular Engineering by atom transfer radical polymerization”, JACS, 136, 6513-6533 (2014), which describes a process for controlled block polymerization in order to form block copolymers.

The polymerization may advantageously be carried out starting from at least two types of α,β-unsaturated monomers and a polymerization initiator comprising an end chain I.

The polymerization is typically carried out in a solvent under inert atmosphere at a reaction temperature generally ranging from 0 to 200° C., preferably from 50° C. to 130° C. The solvent may be chosen from polar solvents, in particular ethers such as anisole (methoxybenzene) or tetrahydrofuran or apolar solvents, in particular paraffins, cycloparaffins, aromatics and alkylaromatics having from 1 to 19 carbon atoms, for example benzene, toluene, cyclohexane, methylcyclohexane, n-butene, n-hexane, n-heptane and the like.

The different polymerization conditions and techniques are widely described in the literature and form part of the general knowledge of those skilled in the art. For the atom transfer radical polymerization (ATRP), the reaction is generally carried out under vacuum in the presence of an initiator, a ligand and a catalyst. Mention may be made, as example of a ligand, of N,N,N′,N″,N″-Pentamethyldiethylenetriamine (PMDETA), 1,1,4,7,10,10-hexamethyltriethylenetetramine (HMTETA), 2,2′-Bipyridine (BPY) and Tris(2-pyridylmethyl)amine (TPMA). Mention may be made, as example of a catalyst, of: CuX, CuX₂, with X=Cl, Br and complexes based on ruthenium Ru²⁺/Ru³⁺.

The ATRP polymerization is preferably carried out in a solvent chosen from polar solvents.

Depending on the controlled block polymerization technique, it may also be envisaged to work under pressure.

The block A consists of a chain of structural units derived from one or more α,β-unsaturated alkyl methacrylate or acrylate monomers. The α,β-unsaturated monomer of the block A is preferably chosen from linear or branched C₁ to C₃₄, preferably C₆ to C₂₄, more preferentially C₈ to C₂₄ alkyl methacrylates or acrylates.

The block B consists of a chain of structural units derived from one or more α,β-unsaturated monomers chosen from styrene derivatives, the aromatic ring of which is substituted by at least one group R chosen from the groups:
C₁ to C₂₄, preferably C₁ to C₁₂ alkyl esters, more preferentially the acetoxy group, and
linear or branched, preferably acyclic, C₁ to C₁₂, preferably C₁ to C₈, hydrocarbon-based chains, more preferentially alkyl groups, said chain optionally being substituted by one or more groups containing a quaternary ammonium salt, preferably a trialkylammonium salt.

According to a particular embodiment, the α,β-unsaturated monomer of the block B is chosen from styrene derivatives, the aromatic ring of which is substituted by at least one C₁ to C₂₄, preferably C₁ to C₁₂ alkyl ester group, preferably the acetoxy group. The alkyl ester group may be in the ortho, meta or para position on the aromatic ring, preferably in the para position.

According to another particular embodiment, the α,β-unsaturated monomer of the block B is chosen from styrene derivatives, the aromatic ring of which is substituted by at least one linear or branched, preferably acyclic, C₁ to C₁₂, preferably C₁ to C₈ hydrocarbon-based chain, preferably an alkyl group, said chain optionally being substituted by one or more groups containing a quaternary ammonium salt, preferably a trialkylammonium salt.

Advantageously, the aromatic ring of the α,β-unsaturated monomer of the block B comprises one or more groups containing a quaternary ammonium salt, preferably a trialkylammonium salt.

Advantageously, the α,β-unsaturated monomer of the block B is chosen from the isomers of (vinylbenzyl)trialkylammonium salts, pure or in a mixture. The substituent of the styrene ring may be in the ortho, meta or para position, preferably in the para position. Preference will be given to (vinylbenzyl)trialkylammonium salts.

The alkyl substituents of the ammonium are identical or different and are chosen independently from linear or branched, preferably acyclic, C₁ to C₁₀, preferably C₁ to C₄ alkyls, more preferentially the methyl or ethyl group.

The counterion of the quaternary ammonium salt may be chosen from hydroxide and halide ions and organic anions, such as carboxylates or alkoxides. Hydroxide or halide ions, preferably chloride, will preferably be chosen.

According to a particular embodiment, the block copolymer comprises an end chain I consisting of a cyclic or acyclic, saturated or unsaturated, linear or branched, C₁ to C₃₂, preferably C₄ to C₂₄, more preferentially C₁₀ to C₂₄ hydrocarbon-based chain.

Cyclic hydrocarbon-based chain is intended to mean a hydrocarbon-based chain, at least a portion of which is cyclic, especially aromatic. This definition does not exclude hydrocarbon-based chains comprising both an acyclic portion and a cyclic portion.

The end chain I may comprise an aromatic hydrocarbon-based chain, for example benzene, and/or a saturated and acyclic, linear or branched hydrocarbon-based chain, in particular an alkyl chain.

The end chain I is preferably chosen from preferably linear alkyl chains, more preferentially alkyl chains having at least 4 carbon atoms, even more preferentially having at least 12 carbon atoms.

The end chain I is located at the terminal position of the block copolymer. It may be introduced into the block copolymer by virtue of the polymerization initiator. Thus, the end chain I may advantageously constitute at least a portion of the polymerization initiator, and is positioned within the polymerization initiator in order to make it possible to introduce, during the first step for initiating polymerization, the end chain I at the terminal position of the block copolymer.

The polymerization initiator is, for example, chosen from the free radical initiators used in the ATRP polymerization process. These free radical initiators which are well known to those skilled in the art are especially described in the paper “Atom Transfer Radical Polymerization: current status and future perspectives, Macromolecules, 45, 4015-4039, 2012”.

The polymerization initiator is, for example, chosen from the alkyl esters of carboxylic acid, substituted by a halide, preferably a bromine in the alpha position, for example ethyl 2-bromopropionate, ethyl α-bromoisobutyrate, benzyl chloride or bromide, ethyl α-bromophenylacetate and chloroethylbenzene. Thus, for example, ethyl 2-bromopropionate may make it possible to introduce the end chain I into the copolymer in the form of a C₂ alkyl chain, and benzyl bromide in the form of a benzyl group.

According to a particular embodiment, the block copolymer is a diblock copolymer. The structure of the block copolymer may be of IAB or IBA type, advantageously IAB. The end chain I may be directly attached to the block A or B, depending on the IAB or IBA structure, respectively, or be connected via a bonding group, for example an ester, amide, amine or ether function. The bonding group then forms a bridge between the end chain I and the block A or B.

According to a particular embodiment, the block copolymer may also be functionalized at the chain end according to any known process, especially by hydrolysis or nucleophilic substitution, in particular for an ATRP polymerization which produces a copolymer having a halide in the terminal position. It is thus possible to introduce an end chain I′ by post-functionalization of the block copolymer.

The end chain I′ advantageously comprises a linear or branched, cyclic or acyclic C₁ to C₃₂, preferably C₁ to C₂₄, more preferentially C₁ to C₁₀ hydrocarbon-based chain, even more preferentially an alkyl group, optionally substituted by one or more groups containing at least one heteroatom chosen from N and O.

For an ATRP polymerization using a metal halide as catalyst, this functionalization may for example be carried out by treating the copolymer IAB or IBA obtained by ATRP with a primary C₁ to C₃₂ alkylamine or a C₁ to C₃₂ alcohol under mild conditions so as not to modify the functions present on the blocks A, B and I.

According to a particular preferred embodiment, the block copolymer is represented by the following formula (I) or (II):

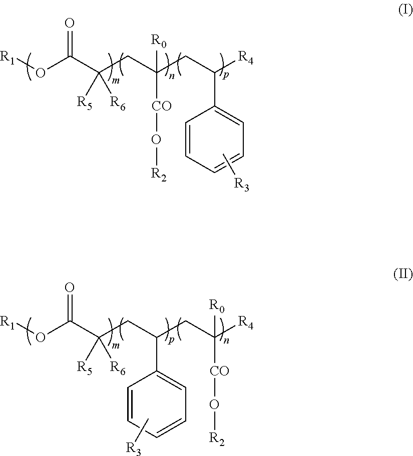

in which
m=0 or 1,
n is an integer between 2 and 20, preferably between 3 and 16,
p is an integer between 2 and 20, preferably between 3 and 16,
R₀ is chosen from hydrogen or the methyl group,
R₁ is chosen from cyclic or acyclic, saturated or unsaturated, linear or branched C₁ to C₃₂, preferably C₄ to C₂₄, more preferentially C₁₀ to C₂₄ hydrocarbon-based chains, even more preferentially alkyl groups,
R₂ is chosen from linear or branched, preferably acyclic, C₁ to C₃₂, preferably C₄ to C₂₄, more preferentially C₁₀ to C₂₄ hydrocarbon-based chains, even more preferentially alkyl groups,
R₃ is a substituent in the ortho, meta or para position, preferably in the para position, on the aromatic ring, chosen from the group consisting of:
   —OCOR₇ groups, in which R₇ is chosen from linear or branched, preferably acyclic, C₁ to C₂₄, preferably C₁ to C₁₂, more preferentially C₁ to C₆ alkyl groups, and
   groups of the following formula (III):

—CH₂—N⁺(R₈)(R₉)(R₁₀)X⁻ (III)
in which
X⁻ is chosen from hydroxide and halide ions and organic anions, preferably chloride, and
R₈, R₉ and R₁₀ are identical or different and are chosen independently from linear or branched, preferably acyclic, C₁ to C₁₀, preferably C₁ to C₄ alkyl groups, more preferentially the methyl or ethyl group,
R₄ is chosen from the group consisting of:
   hydrogen; —OH
   halogens, preferably bromine; and
   cyclic or acyclic, saturated or unsaturated, linear or branched C₁ to C₃₂, preferably C₁ to C₂₄, more preferentially C₁ to C₁₀ hydrocarbon-based chains, preferably alkyl groups, said chains being optionally substituted by one or more groups containing at least one heteroatom chosen from N and O,
R₅ and R₆ are identical or different and are chosen independently from the group consisting of hydrogen and linear or branched, more preferentially acyclic, C₁ to C₁₀, preferably C₁ to C₄ alkyl groups, even more preferentially the methyl group.

In the formulae (I) and (II), the group R₁ may consist of the end chain I as described above and/or the group R₄ may consist of the end chain I′ as described above.

In addition, the molar and/or weight ratio between the block A and B in the block copolymer, and in particular the values m, n, and p of the formulae (I) and (II), will be chosen such that the block copolymer is soluble in the fuel or combustible and/or the organic liquid of the concentrate for which it is intended. Likewise, this ratio and these values m, n and p will be optimized as a function of the fuel or combustible and/or the organic liquid so as to obtain the best properties under cold conditions.

Optimization of the molar and/or weight ratio, especially to define the values m, n and p of the formulae (I) and (II), may be carried out by routine tests accessible to those skilled in the art.

In the block copolymer, the molar ratio between the blocks A and B is advantageously between 1:10 and 10:1, preferably between 1:2 and 2:1, more preferentially between 1:0.5 and 0.5:2.

Other blocks may optionally be present in the block copolymer, as long as they do not fundamentally change the nature of the block copolymer. Preference will nonetheless be given to block copolymers solely containing the blocks A and B.

According to a particular embodiment, the numbers of equivalents of the monomers of the block A and of the block B reacted during the polymerization reaction are identical or different and are independently between 2 and 20, preferably between 3 and 16. Number of equivalents is intended to mean the ratio between the amounts of material (in moles) of the monomers of the block A and of the block B during the polymerization reaction.

According to a particular development of the invention, the block copolymer may advantageously be used as a cold resistance additive for the fuel or combustible derived from one or more sources chosen from the group consisting of mineral, preferably petroleum, animal, vegetable and synthetic sources.

Cold resistance additive is intended to mean an additive which improves the cold resistance properties of a fuel or combustible, in particular the operability under cold conditions during the storage thereof and/or the use thereof at low temperature, typically below 0° C., preferably below −5° C.

The block copolymer is particularly advantageous as additive for fuel or combustible comprising one or more compounds containing n-alkyl, isoalkyl or n-alkenyl substituents having a tendency to crystallize in the fuel or combustible during the storage thereof and/or the use thereof at low temperature.

The fuels or combustibles may be chosen from liquid hydrocarbon-based fuels or combustibles, alone or in a mixture. Liquid hydrocarbon-based fuels or combustibles especially comprise medium distillates of boiling point between 100 and 500° C. These distillates may for example be chosen from the distillates obtained by direct distillation of crude hydrocarbons, vacuum distillates, hydrotreated distillates, distillates derived from catalytic cracking and/or hydrocracking of vacuum distillates, distillates resulting from conversion processes of ARDS (atmospheric residue desulfurization) and/or viscoreduction type, distillates derived from the upgrading of Fischer-Tropsch fractions, distillates resulting from BTL (biomass-to-liquid) conversion of vegetable and/or animal biomass, taken alone or in combination, and/or biodiesels of animal and/or vegetable origin and/or oils and/or esters of vegetable and/or animal oils.

The sulfur content of the fuels or combustibles is preferably less than 5000 ppm, preferably less than 500 ppm, and more preferentially less than 50 ppm, or even less than 10 ppm, and advantageously they are sulfur-free.

The fuel or combustible is preferably chosen from gas oils, biodiesels, gas oils of Bₓ type, and fuel oils, preferably domestic fuel oils (DFOs).

Gas oil of Bₓ type for a diesel engine (compression engine) is intended to mean a gas oil fuel which contains x % (v/v) of esters of vegetable or animal oils (including used cooking oils), converted by a chemical process referred to as transesterification which causes this oil to react with an alcohol in order to obtain fatty acid esters (FAEs). With methanol and ethanol, fatty acid methyl esters (FAMEs) and fatty acid ethyl esters (FAEEs) are obtained, respectively. The letter B followed by a number indicates the percentage of FAE contained in the gas oil. Thus, a B99 contains 99% of FAE and 1% of medium distillates of fossil origin, B20 contains 20% of FAE and 80% of medium distillates of fossil origin, etc. A distinction is therefore made between gas oil fuels of B₀ type, which do not contain oxygen-based compounds, and gas oil fuels of Bx type, which contain x % (v/v) of esters of vegetable oils or of fatty acids, most commonly methyl esters (VOME or FAME). When the FAE is used alone in engines, the fuel is denoted by the term B100.

According to a particular development, the fuel or combustible is chosen from gas oils, biodiesels and gas oils of Bₓ type.

According to a particular embodiment, the block copolymer described above is used as a sedimentation-inhibiting additive. The block copolymer advantageously makes it possible to delay or prevent the sedimentation of crystals of compounds containing n-alkyl, isoalkyl or n-alkenyl substituents. In particular, the block copolymer may advantageously be used to delay or prevent the sedimentation of crystals of n-alkanes, preferably n-alkanes containing at least 12 carbon atoms, more preferentially at least 20 carbon atoms, even more preferentially at least 24.

The block copolymer is advantageously also used as cold resistance additive in combination with at least one cold flow improver (CFI) additive which improves the low-temperature flow properties of the fuel or combustible during the storage thereof and/or the use thereof at low temperature.

The cold flow improver (CFI) additive is preferably chosen from copolymers and terpolymers of ethylene and vinyl and/or acrylic ester(s), alone or in a mixture. Mention may be made, by way of example, of unsaturated ester and ethylene copolymers, such as ethylene/vinyl acetate (EVA), ethylene/vinyl propionate (EVP), ethylene/vinyl ethanoate (EVE), ethylene/methyl methacrylate (EMMA), and ethylene/alkyl fumarate copolymers, described, for example, in documents U.S. Pat. No. 3,048,479, U.S. Pat. No. 3,627,838, U.S. Pat. No. 3,790,359, U.S. Pat. No. 3,961,961 and EP261957.

The cold flow improver (CFI) additive is advantageously chosen from copolymers of ethylene and vinyl ester(s), alone or in a mixture, in particular ethylene/vinyl acetate (EVA) and ethylene/vinyl propionate (EVP) copolymers, more preferentially ethylene/vinyl acetate (EVA) copolymers.

The block copolymer is advantageously used to amplify the fluidizing (flow) effect of the cold flow improver (CFI) additive by improving the cold filter plugging point (CFPP) of the fuel or combustible, the CFPP being measured according to standard NF EN 116.

This effect is usually referred to as the “CFPP booster” effect, insofar as the presence of the block copolymer improves the fluidizing effect of the CFI additive. This improvement is reflected in particular in a significant lowering of the CFPP of the fuel or combustible composition additized with this combination, compared to the same fuel or combustible composition additized solely with the CFI additive, at the same level of treatment. A significant lowering of the CFPP is generally reflected in a reduction of the CFPP by at least 3° C. according to standard NF EN 116.

In this case, the block copolymer has a dual effect, “CFPP booster” and sedimentation inhibitor.

The block copolymer may be added to fuels or combustibles within the refinery and/or be incorporated downstream of the refinery, optionally in a mixture with other additives, in the form of an additive concentrate, also referred to as “additive package” depending on the use.

The block copolymer is used as cold resistance additive in the fuel or combustible at a content, advantageously, of at least 10 ppm, preferably at least 50 ppm, more preferentially at a content of between 10 and 5000 ppm, even more preferentially between 10 and 1000 ppm.

According to another particular embodiment, an additive concentrate comprises the block copolymer as described above, in a mixture with an organic liquid.

The organic liquid must be inert with respect to the block copolymer and miscible with the fuels or combustibles as described above. Miscible is intended to mean the fact that the block copolymer and the organic liquid form a solution or a dispersion so as to facilitate the mixing of the block copolymer into fuels or combustibles according to conventional processes for additivation of fuels or combustibles.

In particular, the organic liquid must be miscible with fuels or combustibles comprising one or more compounds containing n-alkyl, isoalkyl or n-alkenyl substituents having a tendency to crystallize in said fuel or a combustible during the storage thereof and/or the use thereof at low temperature. The fuel or combustible is preferably chosen from gas oils, biodiesels, gas oils of Bₓ type, and fuel oils, preferably domestic fuel oils (DFOs).

The organic liquid is advantageously chosen from aromatic hydrocarbon-based solvents such as the solvent sold under the name Solvesso, alcohols, ethers and other oxygen-based compounds and paraffinic solvents such as hexane, pentane or isoparaffins, alone or in a mixture.

The additive concentrate advantageously comprises at least one cold flow improver (CFI) additive which improves the cold resistance, preferably which improves the low-temperature flow properties of the fuel or combustible during the storage thereof and/or the use thereof at low temperature. The cold flow improver (CFI) additive is preferably chosen from copolymers and terpolymers of ethylene and vinyl and/or acrylic ester(s), alone or in a mixture, as described above.

The additive concentrate may also comprise one or more other additives commonly used in fuels and combustibles, different from the block copolymer described above.

The additive concentrate may typically comprise one or more other additives chosen from detergents, anti-corrosion agents, dispersants, demulsifiers, antifoaming agents, biocides, reodorants, cetane boosters, friction modifiers, lubricity additives or oiliness additives, combustion aids (catalytic promoters of combustion and of soot), agents for improving the cloud point, pour point, the CFPP, sedimentation-inhibiting agents, antiwear agents and/or conductivity modifiers.

Among these additives, mention may in particular be made of:
a) cetane boosters, especially chosen from (but not limited to) alkyl nitrates, preferably 2-ethylhexyl nitrate, aryl peroxides, preferably benzyl peroxide, and alkyl peroxides, preferably tert-butyl peroxide;
b) antifoaming additives, especially chosen from (but not limited to) polysiloxanes, alkoxylated polysiloxanes, and amides of fatty acids derived from vegetable or animal oils. Examples of such additives are given in EP861882, EP663000, EP736590;
c) detergent and/or anti-corrosion additives, especially chosen from (but not limited to) the group consisting of amines, succinimides, alkenyl succinimides, polyalkylamines, polyalkyl polyamines, polyetheramines, quaternary ammonium salts and triazole derivatives; examples of such additives are given in the following documents: EP0938535, US2012/0010112 and WO2012/004300.
d) lubricity additives or antiwear agents, especially chosen from (but not limited to) the group consisting of fatty acids and their ester or amide derivatives, especially glycerol monooleate, and derivatives of mono- and polycyclic carboxylic acids. Examples of such additives are given in the following documents: EP680506, EP860494, WO98/04656, EP915944, FR2772783, FR2772784.
e) cloud point additives, especially chosen from (but not limited to) the group consisting of terpolymers of long-chain olefin/(meth)acrylic ester/maleimide, and polymers of esters of fumaric/maleic acids. Examples of such additives are given in FR2528051, FR2528051, FR2528423, EP112195, EP172758, EP271385, EP291367;
f) anti-sedimentation additives and/or dispersants of paraffins, especially chosen from (but not limited to) the group consisting of (meth)acrylic acid/alkyl (meth)acrylate copolymers amidated by a polyamine, polyamine alkenylsuccinimides, derivatives of phthalamic acid and double-chain fatty amine; alkyl phenol resins. Examples of such additives are given in the following documents: EP261959, EP593331, EP674689, EP327423, EP512889, EP832172; US2005/0223631; U.S. Pat. No. 5,998,530; WO93/14178.
g) polyfunctional additives for cold operability chosen from the group consisting of polymers based on olefin and alkenyl nitrate as described in EP573490;

These other additives are generally added in an amount ranging from 100 to 1000 ppm (each).

The use of such an additive concentrate may be the same as that of the block copolymer described above; in particular, the concentrate may be used for delaying or preventing the sedimentation of crystals of compounds containing n-alkyl, isoalkyl or n-alkenyl substituents from the fuel or combustible during the storage thereof and/or the use at low temperature.

The additive concentrate may advantageously comprise between 5 and 99 weight %, preferably between 10 and 80%, more preferentially between 25 and 70% of block copolymer as described above.

The additive concentrate may typically comprise between 1 and 95 weight %, preferably 10 to 70%, more preferentially 25 to 60% of organic liquid, the remainder corresponding to the block copolymer and optionally to the other additives different from the block copolymer, as are described above.

Generally, the solubility of the block copolymer in the organic liquids, the fuels or the combustibles described above will especially depend on the weight-average and number-average molar mass, M_{w} and Mₙ, respectively, of the block copolymer. Average molar masses M_{w} and Mₙ of the block copolymer will be chosen such that the block copolymer is soluble in the fuel or combustible and/or the organic liquid of the concentrate for which it is intended.

The average molar masses M_{w} and Mₙ of the block copolymer may also influence the efficacy of this block copolymer as cold resistance additive. Average molar masses M_{w} and Mₙ will therefore be chosen so as to optimize the effect of the block copolymer, especially the CFPP and sedimentation-inhibiting effect in the fuels or combustibles described above.

The average molar masses M_{w} and Mₙ may be optimized by routine tests accessible to those skilled in the art.

According to a particular embodiment, the block copolymer advantageously has a weight-average molar mass (Mw) of between 1000 and 30 000 g.mol⁻¹, preferably between 4000 and 10 000 g.mol⁻¹, more preferentially less than 4000 g.mol⁻¹, and/or a number-average molar mass (Mn) of between 1000 and 15 000 g.mol⁻¹, preferably between 4000 and 10 000 g.mol⁻¹, more preferentially less than 4000 g.mol⁻¹. The number- and weight-average molar masses are measured by size exclusion chromatography (SEC). The operating conditions of SEC, especially the choice of solvent, will be chosen as a function of the chemical functions present within the block copolymer according to the invention.

According to a particular embodiment, a fuel or combustible composition is prepared according to any known process, by additizing:
(1) a fuel or combustible with:
(2) at least one block copolymer, and
(3) a cold flow improver (CFI) additive which improves the cold resistance of the fuel or combustible, the fuel or combustible, the copolymer and the cold flow improver (CFI) additive being as described above.

The block copolymer is present in the fuel or combustible composition in a sufficient amount to delay or prevent the sedimentation of the crystals from said compounds containing n-alkyl, isoalkyl or n-alkenyl substituents during the storage and/or use of said fuel or combustible (1) at low temperature.

The fuel or combustible composition advantageously comprises at least 10 ppm, preferably at least 50 ppm, advantageously between 10 and 5000 ppm, more preferentially between 10 and 1000 ppm of the block copolymer described above.

The cold flow improver (CFI) additive is preferably chosen from copolymers and terpolymers of ethylene and vinyl and/or acrylic ester(s), alone or in a mixture. The cold flow improver (CFI) additive is advantageously chosen from copolymers of ethylene and vinyl ester(s), alone or in a mixture, in particular ethylene/vinyl acetate (EVA) and ethylene/vinyl propionate (EVP) copolymers, more preferentially ethylene/vinyl acetate (EVA) copolymers.

The cold flow improver (CFI) additive is present in the fuel or combustible composition in a sufficient amount to improve the low-temperature flow behavior of the fuel or combustible (1) during the storage thereof and/or the use thereof at low temperature.

The fuel or combustible composition advantageously comprises at least 10 ppm, preferably at least 50 ppm, more preferentially between 10 and 5000 ppm, even more preferentially between 10 and 1000 ppm of the cold flow improver (CFI) additive.

Aside from the block copolymer (2) and the cold flow improver additive (3) described above, the fuel or combustible composition (1) may also contain one or more other additives different from the additives (2) and (3), chosen from detergents, anti-corrosion agents, dispersants, demulsifiers, antifoaming agents, biocides, reodorants, cetane boosters, friction modifiers, lubricity additives or oiliness additives, combustion aids (catalytic promoters of combustion and of soot), agents for improving the cloud point, pour point, or CFPP, sedimentation-inhibiting agents, antiwear agents and/or conductivity modifiers.

The additives different from the additives (2) and (3) are, for example, those mentioned above.

According to another particular embodiment, a process for improving the cold resistance properties of a fuel or combustible composition, derived from one or more sources chosen from the group consisting of mineral, preferably petroleum, animal, vegetable and synthetic sources, comprises the following successive steps of:

a) determining the most well adapted additive composition to the fuel or combustible composition to be treated, and also the level of treatment necessary to achieve a given specification relating to the cold resistance properties for the specific fuel or combustible composition, said composition comprising at least the block copolymer according to the invention, optionally in combination with a cold flow improver (CFI) additive. Alternatively, the additive composition consists of the additive concentrate according to the invention.

b) treating the fuel or combustible composition with the amount determined in step a) of block copolymer and optionally with the cold flow improver (CFI) additive.

It is understood that the process for improving the cold resistance properties is advantageously intended for a fuel or combustible composition comprising one or more compounds containing n-alkyl, isoalkyl or n-alkenyl substituents having a tendency to crystallize in said fuel or combustible during the storage thereof and/or the use thereof at low temperature.

Step a) is carried out according to any known process and forms part of common practice in the field of additivation of fuels or combustibles. This step involves defining a characteristic representative of the cold resistance properties of the fuel or combustible, for example sedimentation-inhibiting characteristics, setting the target value, then determining the required improvement to achieve the specification.

The amount of block copolymer to be added to the fuel or combustible composition in order to achieve the specification will typically be determined by comparison with the fuel or combustible composition containing the CFI additive but without the block copolymer.

The amount of block copolymer necessary to treat the fuel or combustible composition may vary as a function of the nature and the origin of the fuel or combustible, in particular as a function of the content of compounds containing n-alkyl, isoalkyl or n-alkenyl substituents. The nature and the origin of the fuel or combustible may therefore also be a factor to be taken into account for step a).

The process for improving the cold resistance properties may also comprise an additional step after step b), for verifying the achievement of the target and/or adjusting the level of treatment with the block copolymer as cold resistance additive and optionally with the cold flow improver (CFI) additive.

### EXAMPLES

### Syntheses of Block Copolymers of Formula (I) by Atom Transfer Radical Polymerization (ATRP)

Starting Products:
Monomer A: octadecyl acrylate (CAS 4813-57-4) or dodecyl acrylate (CAS 2156-97-0)
Monomer B: 4-acetoxystyrene (CAS 2628-16-2) or N,N,N-trimethylammonium vinylbenzene chloride (CAS 26616-35-3)
Initiator I: ethyl 2-bromopropionate (CAS 535-11-5) or octadecyl 2-bromopropionate
Catalyst: copper bromide (CAS 7787-70-4)
Ligand: 1,4,7,10,10-hexamethyltriethylenetetramine (CAS 3083-10-1)

Synthesis of octadecyl 2-bromopropionate

12 g of octadecanol (44 mmol, 1 eq) and 7.4 g of triethylamine (53 mmol, 1.2 eq) are dissolved in 110 ml of cryodistilled THF. 5.81 ml of 2-bromopropionyl bromide (55 mmol, 1.25 eq) are dissolved in 10 ml of cryodistilled THF. At 0° C., the solution of 2-bromopropionyl bromide is added dropwise to the octadecanol solution. The solution is placed under magnetic stirring at 0° C. for 2 h then at T ambient for 12 h. The THF is evaporated on the rotary evaporator and the octadecyl 2-bromopropionate is dissolved in 100 ml of dichloromethane. The organic phase is washed twice with an aqueous solution of 10% hydrochloric acid, three times with water, twice with an aqueous solution of 1 M sodium hydroxide then three times with water. The organic phase is dried with sodium sulfate. The solvent is evaporator on the rotary evaporator then the octadecyl 2-bromopropionate is dried under vacuum. Weight yield=98%.

¹H NMR (400 MHz, 293 K, ppm in CDCl₃): δ 4.35 (q, 1H, e), 4.15 (m, 2H, d), 1.80 (d, 3H, f), 1.65 (tt, 2H, c), 1.24 (m, 30H, b), 0.87 (t, 3H, a).

### Example 1

### Synthesis of a dodecyl acrylate/4-acetoxystyrene IAB Block Copolymer

A solution of initiator I is prepared by dissolving 1 equivalent of octadecyl 2-bromopropionate (1 g, 405 g.mol⁻¹) in 4 ml of anisole. The solution is degassed by nitrogen bubbling before use.
A solution of monomer A/catalyst/ligand is obtained by dissolving 7 equivalents of dodecyl acrylate (4.15 g, 240 g.mol⁻¹), 0.4 equivalent of copper bromide (142 mg, 143 g.mol⁻¹) and 0.4 equivalent of 1,1,4,7,10,10-hexamethyltriethylenetetramine (227 mg, 230 g.mol⁻¹) in 8 ml of anisole, then degassing the solution thus obtained by nitrogen bubbling.
A solution of monomer B/catalyst/ligand is obtained by dissolving 14 equivalents of 4-acetoxystyrene (5.61 g, 162 g.mol⁻¹), 0.4 equivalent of copper bromide (142 mg, 143 g.mol⁻¹) and 0.4 equivalent of 1,1,4,7,10,10-hexamethyltriethylenetetramine (227 mg, 230 g.mol⁻¹) in 4 ml of anisole.

The initiator solution is added under a nitrogen stream to the solution of monomer A/catalyst/ligand. The mixture is placed under vacuum with magnetic stirring at 90° C. and protected from light. The progression of the reaction is monitored by ¹H NMR spectroscopic analysis (Bruker 400 MHz spectrometer). After 10 h of reaction, all the dodecyl acrylate has been consumed. After degassing by nitrogen bubbling, the solution of monomer B/catalyst/ligand is then added to the reaction medium. After 18 h, 97% of the 4-acetoxystyrene has been consumed. After 18 h at 90° C., the reaction is stopped by immersing the round-bottomed flask in liquid nitrogen. 100 ml of tetrahydrofuran are added to the reaction medium, then the solution thus obtained is passed over a basic alumina column. The solvent is evaporated on the rotary evaporator; 8.1 g (4240 g.mol⁻¹, weight yield of 76%) of the block copolymer b-I₁₈A¹²₇B^{ac}₁₃ are obtained after precipitation in 400 ml of cold methanol, centrifugation and drying under vacuum.

¹H NMR (400 MHz, 293 K, ppm in CDCl₃): δ 6.3-7.0 (m, Ar), 4.05 (m, 3+7), 2.2 (m, g), 1.3-1.8 (m, c+d+4+8) 1.0-1.3 (m, 5+9), 0.8 (t, 6+10).

Other block copolymers of formula (I) described above were synthesized according to the same protocol as example 1, but varying the nature of the monomers A and B and their ratios. The characteristics of the block copolymers obtained are listed in the following table 1:

TABLE 1

| Ref.⁽¹⁾ | | m | n | p | R₀ | R₁ | R₂ | R₃ | R₄⁽²⁾ |
|---|---|---|---|---|---|---|---|---|---|
| b-I₁₈A¹²₇B^{ac}₁₃ | (I) | 1 | 7 | 13 | H | —C₁₈H₃₇ | —C₁₂H₂₅ | —OCOR₆ | Br |
| b-I₁₈A¹²₁₁B^{ac}₁₂ | (I) | 1 | 11 | 12 | H | —C₁₈H₃₇ | —C₁₂H₂₅ | —OCOR₆ | Br |
| b-I₁₈A¹²₁₃B^{aq}₄ | (I) | 1 | 13 | 4 | H | —C₁₈H₃₇ | —C₁₂H₂₅ | Formula | Br |
| | | | | | | | | (III) | |
| | | | | | | | | Mn⁽³⁾ | Yield⁽⁴⁾ |
| Ref. ⁽¹⁾ | R₅ | R₆ | R₇ | R₈ | R₉ | R₁₀ | X | g · mol⁻¹ | (%) |
| b-I₁₈A¹²₇B^{ac}₁₃ | —CH₃ | H | —CH₃ | — | — | — | — | 6000 | 76 |
| b-I₁₈A¹²₁₁B^{ac}₁₂ | —CH₃ | H | —CH₃ | — | — | — | — | 7700 | 78 |
| b-I₁₈A¹²₁₃B^{aq}₄ | —CH₃ | H | — | —CH₃ | —CH₃ | —CH₃ | Cl | 4200 | 43 |

⁽¹⁾The values m, n and p are determined by ¹H NMR spectroscopic analysis (Bruker 400 MHz spectrometer).
⁽²⁾It is possible to have mixtures of copolymers in which R₄ = Br and/or H and/or OH and/or group resulting from side reaction phenomena of recombination during radical polymerization.
⁽³⁾Number-average molar mass determined by size exclusion chromatography (SEC).
For the sample b-I₁₈A¹²₁₃B^{aq}₄ containing a quaternary ammonium, the molar masses are measured by a Viscotek GPC Max TDA 305 apparatus from Malvern, fitted with two PLGel Mixed C gel columns from Agilent and an ionizing radiation detector. The solvent used is chloroform (+1% of triethylamine) and the flow is set at 1 ml · min⁻¹. Calibration is carried out with polystyrene standard samples with low dispersities.
For the other samples, the values are measured by a Varian apparatus fitted with TOSOHAAS TSK gel columns and an ionizing radiation detector. The solvent used is THF and the flow is set at 1 ml · min⁻¹. Calibration is carried out with polystyrene standard samples with low dispersities.
⁽⁴⁾Weight yield.

### Comparative Examples

### Synthesis of Statistical Copolymers of Formula (I) by Atom Transfer Radical Polymerization (ATRP)

### Example 2

### Synthesis of a dodecyl acrylate/4-acetoxystyrene Statistical Copolymer

A solution of initiator I is prepared by dissolving 1 equivalent of octadecyl 2-bromopropionate (1 g, 405 g.mol⁻¹) in 4 ml of anisole. The solution is degassed by nitrogen bubbling. 11 equivalents of dodecyl acrylate (6.53 g, 240 g.mol⁻¹) purified beforehand on a basic alumina column, 14 equivalents of 4-acetoxystyrene (5.61 g, 162 g.mol⁻¹) purified beforehand on a basic alumina column, 0.4 equivalent of copper bromide (0.142 mg, 143 g.mol⁻¹) and 0.4 equivalent of 1,1,4,7,10,10-hexamethyltriethylenetetramine (227 mg, 230 g.mol⁻¹) are dissolved in 8 ml of anisole.

The solution is degassed by nitrogen bubbling.

The solution of initiator I is added to the solution of monomers under a stream of nitrogen, then the mixture is placed under magnetic stirring at 90° C. and protected from light.

The progression of the reaction is monitored by ¹H NMR spectroscopic analysis (Bruker 400 MHz spectrometer).

After 17 h at 90° C., the reaction is stopped by immersing the round-bottomed flask in liquid nitrogen. 100 ml of THF are added, then the mixture is passed over a basic alumina column in order to eliminate the catalyst. The copolymer is precipitated in 400 ml of cold methanol then dried under vacuum. 10 g (5060 g.mol⁻¹, weight yield of 79%) of the statistical copolymer s-I₁₈A¹²₁₀B^{ac}₁₄ are obtained after precipitation in 400 ml of cold methanol and drying under vacuum.

¹H NMR (400 MHz, 293 K, ppm in CDCl₃): δ 6.3-7.0 (m, Ar), 4.05 (m, 3+7), 2.2 (m, g), 1.3-1.8 (m, c+d+4+8) 1.0-1.3 (m, 5+9), 0.8 (t, 6+10).

### Example 3

### Synthesis of a dodecyl acrylate/4-acetoxystyrene Statistical Copolymer

Another statistical copolymer s-I₁₈A¹²₇B^{ac}₁₄ was synthesized according to the same protocol as example 2, but using 7 equivalents of dodecyl acrylate instead of 11. (Weight yield of 74%)

The characteristics of the statistical copolymers obtained are listed in the following table 2:

TABLE 2

| | | | | | | | | | | | | | Mn⁽³⁾ | Yield⁽⁴⁾ |
|---|---|---|---|---|---|---|---|---|---|---|---|---|---|---|
| Ref. ⁽¹⁾ | | m | n | p | R₀ | R₁ | R₂ | R₃ | R₄⁽²⁾ | R₅ | R₆ | R₇ | g · mol⁻¹ | (%) |
| s-I₁₈A¹²₁₀B^{ac}₁₄ | (I) | 1 | 10 | 14 | H | —C₁₈H₃₇ | —C₁₂H₂₅ | —OCOR₆ | Br | —CH₃ | H | —CH₃ | 6700 | 79 |
| s-I₁₈A¹²₇B^{ac}₁₄ | (I) | 1 | 7 | 14 | H | —C₁₈H₃₇ | —C₁₂H₂₅ | —OCOR₆ | Br | —CH₃ | H | —CH₃ | 7500 | 74 |

Evaluation of the Performance Under Cold Conditions of the Copolymers in a Fuel Composition

The copolymers listed in tables 1 and 2 are tested as sedimentation-inhibiting additive in an engine gas oil distillate of B₇ type, GOM, the characteristics of which are listed in table 3 below:

TABLE 3

| GOM | GOM (B₇) | | | | |
|---|---|---|---|---|---|
| % Total paraffins, measured | 20.39 | | | | |
| by two-dimensional gas | | | | | |
| chromatography (2DGC) | | | | | |
| (total weight %) | | | | | |
| Number of carbons | 7 | 8 | 9 | 10 | 11 |
| (weight %) | 0.09 | 0.19 | 1.26 | 2.08 | 2.11 |
| Number of carbons | 12 | 13 | 14 | 15 | 16 |
| (weight %) | 1.93 | 1.67 | 1.74 | 1.55 | 1.24 |
| Number of carbons | 17 | 18 | 19 | 20 | 21 |
| (weight %) | 1.10 | 1.16 | 1.00 | 0.87 | 0.74 |
| Number of carbons | 22 | 23 | 24 | 25 | 26 |
| (weight %) | 0.59 | 0.36 | 0.33 | 0.21 | 0.14 |
| Number of carbons | 27 | 28 | | | |
| (weight %) | 0.06 | 0 | | | |

| | |
|---|---|
| CFPP (° C.) NF EN 116 | −7 |
| Pour point (° C.) ASTM | −12 |
| D97 | |
| Cloud point (° C.) ASTM | −8 |
| D7689 | |
| MV15 (kg/m³) NF EN | 837.3 |
| ISO12185 | |
| Sulfur content (mg/kg) | <10 |
| VOME content (vol %) | 7 |

Distillation ASTM D86 (° C.)

| 0% | 5% | 10% | 20% | 30% | 40% | 50% | 60% | 70% |
|---|---|---|---|---|---|---|---|---|
| 163.8 | 185.1 | 191.4 | 205.5 | 223.8 | 242.5 | 261.3 | 281.1 | 300.5 |
| 80% | 90% | 95% | 100% | | | | | |
| 318.9 | 337.2 | 350.2 | 360.5 | | | | | |

Preparation and Cold Resistance property of Fuel Xompositions C₀ to C₅

Each composition C₁ to C₅ is produced by dissolving 100 ppm by weight of copolymer (100% of active substance) in a gas oil composition GOM containing 300 ppm by weight of a cold flow improver (CFI) additive sold under the name CP7936C which is an ethylene-vinyl acetate (EVA) comprising 30.5% w/w of vinyl acetate and concentrated to 70% w/w in an aromatic solvent (Solvesso 150).

By way of comparison, a control composition C₀ was also tested, corresponding to the gas oil GOM containing solely 440 ppm by weight of the EVA cold flow improver (CFI) additive described above, this content corresponding to a level of treatment by polymer equivalent to that of compositions C₁ to C₅.

The performance of the copolymers as sedimentation-inhibiting additive (WASA) is evaluated by testing their ability to prevent the sedimentation of fuel compositions Cₓ additized with conventional EVA. The sedimentation-inhibiting properties of the fuel compositions Cₓ are evaluated by the following sedimentation test ARAL: 250 ml of the fuel composition Cₓ are cooled in 250 ml test tubes in a climatic chamber to −13° C. according to the following temperature cycle: passage from +10° C. to −13° C. in 4 h then isotherm at -13° C. for 16 h. At the end of the test, the visual appearance of the sample and the volume of the sedimented phase are visually assessed, then the bottom 20% of the volume are taken off for characterization of the cloud point (ASTM D7689) and the cold filter plugging point (CFPP). The difference between the cloud point before and after sedimentation is then compared (i.e. on the bottom 20% of the volume of the test tube). The smaller the difference, the better the sedimentation-inhibiting effect. It is generally estimated that an additive has a sedimentation-inhibiting effect when the difference between the cloud point before and after sedimentation is less than 3.

The performance of each copolymer as CFPP booster additive is also evaluated, by testing their ability to lower the cold filter plugging point (CFPP) of the fuel compositions Cₓ additized with conventional EVA.

The results are collated in table 4 below.

TABLE 4

| | | | CFPP | | | Cloud point | | |
|---|---|---|---|---|---|---|---|---|
| | | Volume | measurement | | | measurement | | |
| | | of | (° C.) | | | [° C.] | | |
| Composition | | sediments | NF EN 116 | | Visual | ASTM D7689 | | |
| no. | Ref. | [ml] | Before | After | assessment | Before | After | Difference |
| GOM | | | −7 | | | −8 | | |
| C₀ | | 70 | −21 | −16 | clear | −7 | −1 | 6 |
| C₁ | b-I₁₈A¹²₇B^{ac}₁₃ | 0 | −31 | −28 | cloudy | −7 | −7 | 0 |
| C₂ | b-I₁₈A¹²₁₁B^{a}c₁₂ | 5 | −28 | −29 | cloudy | −7 | −6 | 1 |
| C₃ | b-I₁₈A¹²₁₃B^{aq}₄ | 0 | −23 | −22 | cloudy | −8 | −8 | 0 |
| C₄ | s-I₁₈A¹²₁₀B^{ac}₁₄ | 42 | −23 | −16 | clear | −7 | −2 | 5 |
| C₅ | s-I₁₈A¹²₇B^{ac}₁₄ | 50 | −17 | −5 | clear | −7 | 0 | 7 |

The sedimentation-inhibiting effect is only observed for the fuel compositions C₁, C₂ and C₃. No sedimentation-inhibiting effect is observed for the compositions C₄ and C₅ containing the copolymers obtained by statistical polymerization.

1. A block copolymer comprising:
(i) a block A consisting of a chain of structural units derived from one or more α,β-unsaturated alkyl methacrylate or acrylate monomers, and
(ii) a block B consisting of a chain of structural units derived from one or more α,β-unsaturated monomers chosen from styrene derivatives, the aromatic ring of which is substituted by at least one group R chosen from the groups:
C₁ to C₂₄ alkyl esters, and
linear or branched, preferably acyclic, C₁ to C₁₂ hydrocarbon-based chains, preferably alkyl groups, said chain being substituted by one or more groups containing a quaternary ammonium salt.

2. The block copolymer as claimed in claim 1, characterized in that it also comprises (iii) an end chain I consisting of a cyclic or acyclic, saturated or unsaturated, linear or branched, C₁ to C₃₂ hydrocarbon-based chain, said chain being located at the terminal position of said block copolymer.

3. The block copolymer as claimed in claim 1, characterized in that the α,β-unsaturated monomer of the block A is chosen from linear or branched C₆ to C₃₄ alkyl methacrylates or acrylates.

4. The block copolymer as claimed in claim 1, characterized in that the α,β-unsaturated monomer of the block B is chosen from styrene derivatives, the aromatic ring of which is substituted by at least one C₁ to C₂₄ alkyl ester group, said ester group being in the meta, ortho or para position on the aromatic ring.

5. The block copolymer as claimed in claim 1, characterized in that the α,β-unsaturated monomer of the block B is chosen from styrene derivatives, the aromatic ring of which is substituted by at least one linear or branched, preferably acyclic, C₁ to C₁₂ hydrocarbon-based chain, preferably alkyl groups, said chain being substituted by one or more groups containing a quaternary ammonium salt.

6. The block copolymer as claimed in claim 5, characterized in that the α,β-unsaturated monomer of the block B is chosen from the isomers of (vinylbenzyl)trialkylammonium salts in the ortho, meta or para position, pure or in a mixture.

7. The block copolymer as claimed in claim 6, characterized in that the alkyl substituents of the ammonium are identical or different and chosen independently from linear or branched, preferably acyclic, C₁ to C₁₀ alkyls.

8. The block copolymer as claimed in claim 1, characterized in that it is obtained by controlled block copolymerization.

9. The block copolymer as claimed in claim 8, characterized in that it is obtained by controlled block copolymerization by means of a polymerization initiator comprising (iii) an end chain I consisting of a cyclic or acyclic, saturated or unsaturated, linear or branched, C₁ to C₃₂ hydrocarbon-based chain, said chain being located at the terminal position of said block copolymer.

10. The block copolymer as claimed in claim 9, characterized in that the copolymer is a diblock copolymer.

11. The block copolymer as claimed in claim 1, characterized in that it is represented by the following formula (I) or (II): 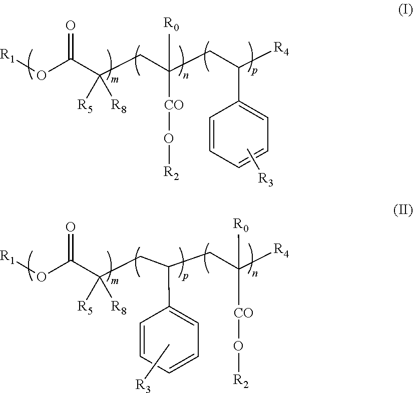
in which
m=0 or 1,
n is an integer between 2 and 20,
p is an integer between 2 and 20,
R₀ is chosen from hydrogen or the methyl group,
R₁ is chosen from cyclic or acyclic, saturated or unsaturated, linear or branched C₁ to C₃₂ hydrocarbon-based chains, preferably alkyl groups,
R₂ is chosen from linear or branched, preferably acyclic, C₁ to C₃₂ hydrocarbon-based chains, preferably alkyl groups,
R₃ is a substituent in the ortho, meta or para position on the aromatic ring, chosen from the group consisting of:
—OCOR₇ groups, in which R₇ is chosen from linear or branched, preferably acyclic, C₁ to C₂₄ alkyl groups, and
groups of the following formula (III):
—CH₂—N⁺(R₈)(R₉)(R₁₀)X⁻ (III)
in which
X⁻ is chosen from hydroxide and halide ions and organic anions, and
R₈, R₉ and R₁₀ are identical or different and chosen independently from linear or branched, preferably acyclic, C₁ to C₁₀ alkyl groups,
R₄ is chosen from the group consisting of:
hydrogen; —OH
halogens, and
cyclic or acyclic, saturated or unsaturated, linear or branched C₁ to C₃₂ hydrocarbon-based chains, preferably alkyl groups, said chains being optionally substituted by one or more groups containing at least one heteroatom chosen from N and O,
R₅ and R₆ are identical or different and chosen independently from the group consisting of hydrogen and linear or branched, more preferentially acyclic, C₁ to C₁₀ alkyl groups.

12. The use of a block copolymer as described in claim 1, as a sedimentation-inhibiting additive.

13. The use as claimed in claim 12, as an additive which improves the cold resistance properties of a fuel or combustible derived from one or more sources chosen from the group consisting of mineral, preferably petroleum, animal, vegetable and synthetic sources, said fuel or a combustible comprising one or more compounds containing n-alkyl, isoalkyl or n-alkenyl substituents having a tendency to crystallize in said fuel or a combustible during the storage thereof and/or the use thereof at low temperature, said block copolymer being used in combination with at least one cold flow improver (CFI) additive which improves the low-temperature flow properties of said fuel or combustible during the storage thereof and/or the use thereof at low temperature.

14. The use as claimed in claim 13, for also amplifying the fluidizing effect of the cold flow improver (CFI) additive by improving the cold filter plugging point (CFPP) according to standard NF EN 116 of said fuel or combustible.

15. An additive concentrate comprising a block copolymer as described in claim 1, in a mixture with an organic liquid, said organic liquid being inert with respect to the block copolymer and miscible with fuels or combustibles derived from one or more sources chosen from the group consisting of mineral, preferably petroleum, animal, vegetable and synthetic sources, said fuel or combustible comprising one or more compounds containing n-alkyl, isoalkyl or n-alkenyl substituents having a tendency to crystallize in said fuel or a combustible during the storage thereof and/or the use thereof at low temperature.

16. The additive concentrate as claimed in claim 15, comprising at least one cold flow improver (CFI) additive which improves the cold resistance, said cold flow improver additive preferably being chosen from copolymers and terpolymers of ethylene and vinyl and/or acrylic ester(s) (EVA and/or EVP), alone or in a mixture.

17. The use of a concentrate as claimed in claim 15 for delaying or preventing the sedimentation of crystals of compounds containing n-alkyl, isoalkyl or n-alkenyl substituents from the fuel or combustible during the storage thereof and/or the use at low temperature.

18. The use as claimed in claim 17, characterized in that the fuel or combustible is chosen from gas oils, bio-gas oils, mixtures of gas oil and bio-gas oil of Bₓ type, and fuel oils, preferably domestic fuel oils (DFOs).

19. A fuel or combustible composition comprising:
(1) a fuel or combustible derived from one or more sources chosen from the group consisting of mineral, preferably petroleum, animal, vegetable and synthetic sources, said fuel or combustible comprising one or more compounds containing n-alkyl, isoalkyl or n-alkenyl substituents having a tendency to crystallize in said fuel or combustible during the storage thereof and/or the use thereof at low temperature,
(2) the block copolymer as described in claim 1, said copolymer being present in the composition in a sufficient amount to delay or prevent the sedimentation of the crystals from said compounds containing n-alkyl, isoalkyl or n-alkenyl substituents during the storage and/or use of said fuel or combustible (1) at low temperature, and
(3) a cold flow improver (CFI) additive improving the cold resistance, preferably chosen from copolymers and terpolymers of ethylene and vinyl and/or acrylic ester(s) (EVA and/or EVP), alone or in a mixture, said additive being present in the fuel or combustible composition in a sufficient amount to improve the flow behavior at low temperature of the fuel or combustible (1) during the storage thereof and/or the use thereof at low temperature.

20. The composition as claimed in claim 19, characterized in that it contains at least 10 ppm, preferably between 10 and 5000 ppm of the block copolymer and at least 10 ppm, preferably between 10 and 5000 ppm of the cold flow improver (CFI) additive.

21. The composition as claimed in claim 19, characterized in that the fuel or combustible is chosen from gas oils, bio-gas oils, mixtures of gas oil and bio-gas oil of Bₓ type, and fuel oils.
